(19) United States
(12) Patent Application Publication
(10) Pub. No.: US 2012/0328377 A1
(43) Pub. Date: Dec. 27, 2012

(54) Resin-Based Sealant Compositions Comprising Cement Kiln Dust and Methods of Use

(75) Inventors: D. Chad Brenneis, Marlow, OK (US); Craig W. Roddy, Duncan, OK (US); Paul J. Jones, Humble, TX (US); Jeffery D. Karcher, Houston, TX (US); Ronnie G. Morgan, Waurika, OK (US)

(73) Assignee: HALLIBURTON ENERGY SERVICES, INC., Houston, TX (US)

(21) Appl. No.: 13/598,052

(22) Filed: Aug. 29, 2012

Related U.S. Application Data
(63) Continuation-in-part of application No. 12/821,412, filed on Jun. 23, 2010, now Pat. No. 8,307,899.
Application No. 12/821,412 is a continuation-in-part of application No. 12/606,381, filed on Oct. 27, 2009, now Pat. No. 7,743,828.
Application No. 12/606,381 is a continuation-in-part of application No. 12/420,630, filed on Apr. 8, 2009, now Pat. No. 7,631,692.
Application No. 12/420,630 is a continuation-in-part of application No. 12/349,676, filed on Jan. 7, 2009, now Pat. No. 7,674,332.
Application No. 12/349,676 is a division of application No. 12/034,886, filed on Feb. 21, 2008, now Pat. No. 7,478,675.
Application No. 12/034,886 is a continuation-in-part of application No. 11/223,669, filed on Sep. 9, 2005, now Pat. No. 7,445,669.

(51) Int. Cl. E02D 31/00; C09K 8/44

(52) U.S. Cl. 405/267; 523/130

(57) ABSTRACT

Methods and compositions are provided that relate to resin-based sealant compositions comprising cement kiln dust. An embodiment discloses a method comprising: providing a resin-based sealant composition comprising a liquid hardenable resin component and kiln dust; and allowing the resin-based sealant composition to harden.

### CROSS-REFERENCE TO RELATED APPLICATIONS

This application is a continuation-in-part of U.S. patent application Ser. No. 12/821,412, entitled “Methods of Plugging and Abandoning a Weil Using Compositions Comprising Cement Kiln Dust and Pumicite,” filed on Jun. 23, 2010, which is a continuation-in-part of U.S. patent application Ser. No. 12/606,381, entitled. “Methods of Cementing Subterranean Formation Formations Using Cement Kiln Dust in Compositions Having Reduced Portland Cement Content,” filed on Oct. 27, 2009, issued as U.S. Pat. No. 7,743,828, which is a continuation-in-part of U.S. application Ser. No. 12/420,630, issued as U.S. Pat. No. 7,631,692, entitled “Settable Compositions Comprising a Natural Pozzolan and Associated Methods,” filed on Apr. 8, 2009, which is a continuation-in-part of U.S. patent application Ser. No. 12/349,676, issued as U.S. Pat. No. 7,674,332, entitled “Extended Settable Compositions Comprising Cement Kiln Dust and Associated Methods,” filed on Jan. 7, 2009, which is a divisional of U.S. patent application Ser. No. 12/034,886, issued as U.S. Pat. No. 7,478,675, entitled “Extended Settable Compositions Comprising Cement Kiln Dust and Associated Methods, filed on Feb. 21, 2008, which is a continuation-in-part of U.S. patent application Ser. No. 11/223,669, issued as U.S. Pat. No. 7,445,669, entitled “Settable Compositions Comprising Cement Kiln Dust and Additive(s),” filed Sep. 9, 2005, the entire disclosures of which are incorporated herein by reference.

### BACKGROUND

The present invention relates to resin-based sealant compositions and, more particularly, in certain embodiments, to resin-based sealant compositions that comprise cement kiln dust (“CKD”) and associated methods of use in servicing well bores.

Sealant compositions may be used in a variety of subterranean applications. For example, in subterranean well construction, a conduit (e.g., pipe string, casing, liners, expandable tubulars, etc.) may be run into a well bore and cemented in place. The process of cementing the pipe string in place is commonly referred to as “primary cementing.” in a typical primary-cementing method, a sealant composition may be pumped into an annulus between the walls of the well bore and the exterior surface of the pipe string disposed therein. The sealant composition may set in the annular space, thereby forming an annular sheath of hardened, substantially impermeable seal (i.e., a sealant sheath) that may support and position the pipe string in the well bore and may bond the exterior surface of the pipe string to the subterranean formation or the inside of a larger conduit. Among other things, the sealant sheath surrounding the pipe string functions to prevent the migration of fluids in the annulus, as well as protecting the pipe string, from corrosion. Sealant compositions also may be used in remedial-cementing methods, for example, to seal voids in pipe strings or cement sheaths, to seal highly permeable formation zones or fractures, to place a cement plug, and the like. As used herein the term “void” refers to any type of space, including fractures, holes, cracks, channels, spaces, and the like. Such voids may include: holes or cracks in the pipe strings; holes, cracks, spaces, or channels in the sheath; and very small spaces (commonly referred to as “micro-annuli”) between the interior surface of the sealant sheath and the exterior surface of the conduit or between the outer surface of the sealant sheath and the formation or inside surface of a larger conduit. Sealing such voids may prevent the undesired flow of fluids (e.g., oil, gas, water, etc.) and/or fine solids into, or from, the well bore. Sealant compositions also may be used in surface applications, for example, construction cementing.

A variety of different sealant compositions, including non-cementitious sealants, such as resin-based sealant compositions have been used in these primary- and secondary-cementing methods. Resin-based sealant compositions may comprise, for example, a liquid hardenable agent component and to hardening agent component. Because resin-based sealant compositions may have increased flexibility and toughness as compared to conventional cement compositions, the resin-based sealant composition may be used, for example, in applications where increased stresses and/or increased number of stress cycles may be encountered. For example, resin-based sealant compositions may have applicability in cementing methods performed in shale formations as wells drilled in these types of formations may require multiple fracturing stages requiring the sealant compositions to have sufficient flexibility and toughness to withstand repeated hydraulic stress and thermal cycles. In addition, resin-based sealant compositions may also be placed into the well bore to plug a void in the conduit (e.g., the pipe string.) or cement sheath or a void that may have formed between the sheath and a wall of the well bore or the conduit. While resin-based sealant compositions may be used instead of conventional cementitious-based sealant compositions in certain applications, drawbacks exist with use of such sealant compositions, including the high cost of the resins, for example.

### SUMMARY

An embodiment of the present invention provides a method comprising: providing a resin-based sealant composition comprising a liquid hardenable resin component and kiln dust; and allowing the resin-based sealant composition to harden.

Another embodiment of the present invention provides a method of forming a seal in a subterranean formation comprising: introducing a resin-based sealant composition into a subterranean formation, wherein the resin-based sealant composition comprises a liquid hardenable resin component and cement kiln dust; and allowing the resin-based sealant composition to harden in the subterranean formation.

Another embodiment of the present invention provides a resin-based sealant composition comprising a liquid hardenable resin component and cement kiln dust.

The features and advantages of the present invention will be readily apparent to those skilled in the art. While numerous changes may be made by those skilled in the art, such changes are within the spirit of the invention.

### DESCRIPTION OF PREFERRED EMBODIMENTS

The present invention relates to resin-based sealant compositions and, more particularly, in certain embodiments, to resin-based sealant compositions that comprise cement kiln dust (“CKD”) and associated methods of use in servicing well bores. One of the many potential advantages of the methods and compositions of the present invention is that the CKD may be used as a non-hydrating filler material to lower the consumption of the more expensive components (e.g., hardenable resin component, etc.) that are typically used in resin-based sealant compositions. Yet another potential advantage is that the CKD may aid the sealing of voids such as cracks that may form in the hardened sealant composition. By way of example, the CKD may hydrate and harden upon contact with water, for example, to counteract the potential formation of voids (e.g., cracks, micro-annuli, etc.) that may form in the hardened sealant composition.

Embodiments of the present invention disclose resin-based sealant compositions comprising a liquid hardenable resin component and CKD. In some embodiments, the resin-based sealant composition may further comprise a liquid hardening agent component for facilitating the set of the hardenable resin component. In other embodiments, the liquid hardenable resin component may auto-catalyze and not require the hardenable resin component for setting. The resin-based sealant compositions may be used in a number different subterranean applications in which the sealant composition may be introduced into a subterranean formation and allowed to harden. One example of a subterranean application includes primary-cementing methods in which the resin-based sealant composition may be allowed to harden in a well-bore annulus. Another example of a subterranean application includes remedial-cementing methods in which the resin-based sealant composition may be allowed, for example, to harden and seal voids in pipe strings or cement sheaths, to seal highly permeable formation zones or fractures, to place a cement plug, and the like.

In some embodiments, the liquid hardenable resin component of the resin-based sealant composition may comprise as hardenable resin, an optional solvent, and an optional aqueous diluent or carrier fluid. As used herein, the term “resin” refers to any of a number of physically similar polymerized synthetics or chemically modified natural resins including thermoplastic materials and thermosetting materials. Examples of hardenable resins that may be used in the liquid hardenable resin component include, but are not limited to, epoxy-based resins, novolak resins, polyepoxide resins, phenol-aldehyde resins, urea-aldehyde resins, urethane resins, phenolic resins, furan resins, furan/furfuryl alcohol resins, phenolic/latex resins, phenol formaldehyde resins, bisphenol A diglycidyl ether resins, butoxymethyl butyl glycidyl ether resins, bisphenol A-epichlorohydrin resins, bisphenol F resins, glycidyl ether resins, polyester resins and hybrids and copolymers thereof, polyurethane resins and hybrids and copolymers thereof, acrylate resins, and mixtures thereof. Some suitable resins, such as epoxy resins, may be cured with an internal catalyst or activator so that when pumped downhole, they may be cured using only time and temperature. Other suitable resins, such as furan resins generally require a time-delayed catalyst or an external catalyst to help activate the polymerization of the resins if the cure temperature is low (i.e., less than 250° F.), but will cure under the effect of time and temperature if the formation temperature is above about 250° F., preferably above about 300° F. It is within the ability of one skilled in the art, with the benefit of this disclosure, to select a suitable resin for use in embodiments of the present invention and to determine whether a catalyst is required to trigger curing. One resin that may be used in particular embodiments of the present invention is the consolidation agent commercially available from Halliburton Energy Services, Inc., of Duncan, Okla., under the trade name “EXPEDITE™.”

Selection of a suitable resin may be affected by the temperature of the subterranean formation to which the composition will be introduced. By way of example, for subterranean formations having a bottom hole static temperature (“BHST”) ranging from about 60° F. to about 250° F., two-component epoxy-based resins comprising a hardenable resin component and a hardening agent component containing specific hardening agents may be preferred. For subterranean formations having a BHST ranging from about 300° F. to about 600° F., a furan-based resin may be preferred. For subterranean formations having a BHST ranging from about 200° F. to about 400° F. either a phenolic-based resin or a one-component HT epoxy-based resin may be suitable. For subterranean formations having a BHST of at least about 175° F., a phenol/phenol fomaldehyde/furfuryl alcohol resin may also be suitable.

Generally, the hardenable resin may be included in the liquid hardenable resin component in an amount in a range of from about 5% to about 100% by volume of the liquid hardenable resin component, in particular embodiments, the hardenable resin may be included in the liquid hardenable resin component in an amount in a range of from about 75% to about 100% by volume of the liquid hardenable resin component. It is within the ability of one skilled in the art with the benefit of this disclosure to determine how much of the hardenable resin may be needed to achieve the desired results. Factors that may affect this decision include the type of hardenable resin and liquid hardening agent used in a particular application.

In some embodiments, a solvent may be added to the resin to reduce its viscosity for ease of handling, mixing and transferring. However, in particular embodiments, it may be desirable not to use such a solvent for environmental or safety reasons. It is within the ability of one skilled in the art with the benefit of this disclosure to determine if and how much solvent may be needed to achieve a viscosity suitable to the subterranean conditions of a particular application. Factors that may affect this decision include geographic location of the well, the surrounding weather conditions, and the desired long-term stability of the resin-based seal ant composition.

Generally, any solvent that is compatible with the hardenable resin and that achieves the desired viscosity effect may be suitable for use in the liquid hardenable resin component of the resin-based sealant composition. Suitable solvents may include, but are not limited to, polyethylene glycol, butyl lactate, dipropylene glycol methyl ether, dipropylene glycol dimethyl ether, dimethyl formamide, diethylene glycol methyl ether, ethyleneglycol butyl ether, diethyleneglycol butyl ether, propylene carbonate, d'limonene, fatty acid methyl esters, and combinations thereof. Selection of an appropriate solvent may be dependent on the hardenable resin chosen. With the benefit of this disclosure, the selection of an appropriate solvent should be within the ability of one skilled in the art. In some embodiments, the amount of the solvent used in the liquid hardenable resin component may be in the range of about 0.1% to about 30% by weight of the liquid hardenable resin component. Optionally, the liquid hardenable resin component may be heated to reduce its viscosity, in place of, or in addition to using a solvent.

Generally, the liquid hardenable resin component may be included in embodiments of the resin-based sealant composition in an amount in a range from about 5% to about 90% by volume of the resin-based sealant composition. In particular embodiments, the liquid hardenable resin component may be included in the resin-based sealant composition in an amount in a range of from about 50% to about 75% by volume of the resin-based sealant composition.

In some embodiments, the resin-based sealant composition may further comprise liquid hardening agent component comprising a hardening agent and an optional silane coupling agent. As used herein, “hardening agent” refers to any substance capable of transforming the hardenable resin into a hardened, consolidated mass. Examples of suitable hardening agents include, but are not limited to, aliphatic amines, aliphatic tertiary amines, aromatic amines, cycloaliphatic amines, heterocyclic amines, amido amines, polyamides, polyethyl amines, polyether amines, polyoxyalkylene amines, carboxylic anhydrides, triethylenetetraamine, ethylene diamine, N-cocoalkyltrimethylene, isophorone diamine, N-aminophenyl piperazine, imidazoline, 1,2-diaminocyclohexane, polyetheramine, diethyltoluenediamine, 4,4′-diaminodiphenyl methane, methyltetrahydrophthalic anhydride, hexahydrophthalic anhydride, maleic anhydride, polyazelaic polyanhydride, phthalic anhydride, and combinations thereof. Specific examples of suitable hardening agents may include, but are not limited to ETHACURE® 100, available from Albernarle Corp. of Raton Rouge, La., and JEFFAMINE® D-230, available from Huntsman Corp. of The Woodlands, Tex. The hardening agent may be included in the liquid hardening agent component in an amount sufficient to at least partially harden the resin composition. In some embodiments of the present invention, the hardening agent used may be included in the liquid hardening agent component in an amount in a range of from about 5% to about 100% by volume of the liquid hardening agent component. In other embodiments, the hardening agent used may be included in the liquid hardening agent component in an amount in a range of from about 50% to about 75% by volume of the liquid hardening agent component.

In some embodiments the hardening agent may comprise a mixture of hardening agents selected to impart particular qualities to the resin-based sealant composition. For example, in particular embodiments, the hardening agent may comprise a fast-setting hardening agent and a slow-setting hardening agent. As used herein, “fast-setting hardening agent” and “slow-setting hardening agent” do not imply any specific rate at which the agents set a hardenable resin; instead, the terms merely indicate the relative rates at which the hardening agents initiate hardening of the resin. Whether as particular hardening agent is considered fast-setting or slow-setting may depend on the other hardening agent(s) with which it is used. In a particular embodiment. ETHACURE® 100 may be used as as slow-setting hardening agent and JEFFAMINE® D-230, may be used as a fast-setting hardening agent. In some embodiments, the ratio of fast-setting hardening agent to slow-setting hardening agent may be selected to achieve a desired behavior of liquid hardening agent component. For example, in some embodiments, the fast-setting hardening agent may be included in the liquid hardening agent component in a ratio of approximately 1:5, by volume, with the slow-setting hardening agent. With the benefit of this disclosure, one of ordinary skill in the art should be able to select the appropriate ratio of hardening agents for use in a particular application.

The liquid hardening agent component of the resin-based sealant composition may also include an optional silane coupling agent. The silane coupling agent may be used, among other things, to act as a mediator to help bond the resin to CKD, the surface of the subterranean formation, and/or the surface of the well bore. Examples of suitable silane coupling agents include, but are not limited to, N-2-(aminoethyl)-3-aminopropyltrimethoxysilane; 3-glycidoxypropyltrimethoxysilane; gamma-aminopropyltriethoxysilane; N-beta-aminoethyl)-gamma-aminopropyltrimethoxysilanes; aminoethyl-N-beta-(aminoethyl)-gamma-aminopropyl-trimethoxysilanes; gamma-ureidopropyl-triethoxysilanes; beta-(3-4 epoxy-cyclohexyl)-ethyl-trimethoxysilane; gamma-glycidoxypropyltrimethoxysilanes; vinyltrichlorosilane; vinyltris (beta-methoxyethoxy) silane; vinyl triethoxysilane; vinyltrimethoxysilane; 3-metacryloxypropyltrimethoxysilane; beta-(3,4 epoxycyclohexyl)-ethyltrimethoxysilane; r-glycidoxypropyltrimethoxysilane; r-glycidoxypropymethylidiethoxysilane; N-beta-(aminoethyl)-r-aminopropyl-trimethoxysilane; N-beta-(aminoethyl)-r-aminopropylmethyldimethoxysilane; 3-aminopropyl-triethoxysilane; N-phenyl-r-aminopropyltrimethoxysilane; r-mercaptopropyltrimethoxysilane; r-chloropropyltrimethoxysilane; vinyltrichlorosilane; vinyltris (beta-methoxethoxy) silane; vinyltrimethoxysilane; r-metacryloxypropyltrimethoxysilane; beta-(3,4 epoxycyclohexyl)-ethyltrimethoxysilane; r-glycidoxypropyltrimethoxysilane; r-glycidoxypropylmethylidiethoxysilane; N-beta-(aminoethyl-r-aminopropyltrimethoxysilane; N-beta-(aminoethyl)-r-aminopropylmethyldimethoxysilane; r-aminopropyltriethoxysilane; N-phenyl-r-aminopropyltrimethysilane; r-mercaptopropyltrimethoxysilane; r-chloropropylmethoxysilane; N [3-(trimethoxysilyl)propyl]-ethylenediamine; substituted silanes where one or more of the substitutions contains a different functional group; and combinations thereof. Generally, the silane coupling agent may be included in the liquid hardening agent component in an amount capable of sufficiently bonding the resin to the particulate. In some embodiments of the present invention, the silane coupling agent may be included in the liquid hardening agent component in an amount in a range of from about 0.1% to about 95% by volume of the liquid hardening agent component. In other embodiments, the silane coupling agent may be included in the liquid hardening agent component in an amount in a range of from about 5% to about 50% by volume of the liquid hardening agent component.

A liquid carrier fluid may also be used in the liquid hardening agent component to, among other things, reduce the viscosity of the liquid hardening agent component for ease of handling, mixing and transferring. However, in some embodiments, it may be desirable, for environmental or safety reasons, not to use a liquid carrier fluid. Any suitable carrier fluid that is compatible with the liquid hardening agent component and achieves the desired viscosity effects may be suitable for use in the present invention. Some suitable liquid carrier fluids are those having high flash points (e.g., above about 125° F.) because of, among other things, environmental and safety concerns; such solvents may include, but are not limited to, polyethylene glycol, butyl lactate, butylglycidyl ether, dipropylene glycol methyl ether, dipropylene glycol dimethyl ether, dimethyl formamide, diethylineglyol methyl ether, ethyleneglycol butyl ether, diethyleneglycol butyl ether, propylene carbonate, d'limonene, fatty acid methyl esters, and combinations thereof. In particular embodiments, selection of an appropriate liquid carrier fluid may be dependent on, inter alia, the resin composition chosen.

Generally, the liquid hardening agent component may be included in the resin-based sealant composition in an amount in a range of from about 1% to about 50% by volume of the resin-based sealant composition. In particular embodiments, the liquid hardening agent component may be included in the resin-based sealant composition in an amount in a range of from about 5% to about 25% by volume of the resin-based sealant composition. In particular embodiments, the amount of liquid hardening agent composition may be selected to impart a desired elasticity or compressibility to a resulting well-bore seal. Generally, the lower the amount of hardening agent present in the resin-based sealant composition, the greater the elasticity or compressibility of a resulting well-bore seal. With the benefit of this disclosure, it should be within the skill of one or ordinary skill in the art to select an appropriate amount of hardening agent to achieve a desired elasticity or compressibility for a particular application.

In some embodiments, the resin-based sealant compositions may further comprise CKD, which is a material generated in the manufacture of cement. CKD, as that term is used herein, refers to a partially calcined kiln feed which is removed from the gas stream and collected, for example, in a dust collector during the manufacture of cement. Usually, large quantities of CKD are collected in the production of cement that are commonly disposed of as waste. Disposal of the CKD as waste can add undesirable costs to the manufacture of the cement, as well as the environmental concerns associated with its disposal. The chemical analysis of CKD from various cement manufactures varies depending on a number of factors, including the particular kiln feed, the efficiencies of the cement production operation, and the associated dust collection systems. CKD generally may comprise a variety of oxides, such as SiO₂, Al₂O₃, Fe₂O₃, CaO, MgO, SO₃, Na₂O, and K₂O. The term “CKD” is used herein to mean cement kiln dust made as described above and equivalent forms of cement kiln dust made in other ways.

In accordance with embodiments of the present invention, the CKD may be used, among other things, as a non-hydrating filler material to lower the consumption of the more expensive components (e.g., hardenable resins, etc.) that are used in the resin-based sealant compositions. While the CKD is a cementitious component that sets and hardens in the presence of water, the CKD should be non-hydrated when mixed with the liquid hardenable resin component and optionally the liquid hardening agent component as the resin-based sealant composition may be non-aqueous, for example. In this manner, the resin-based sealant composition may be placed into a subterranean formation and allowed to harden therein with the CKD remaining non-hydrated. Because the CKD is present in the hardened composition, it is believed that the CKD may help counteract the potential formation of cracks in the hardened composition and/or micro-annulus that may form between the hardened composition and the pipe string or the well-bore wall. In general, the CKD is capable of setting and hardening when contacted by aqueous fluids to inhibit fluid flow through the crack and/or micro-annulus. Accordingly, the CKD may prevent and/or reduce the loss of zonal isolation in spite of the formation of cracks and/or micro-annulus, potentially resulting in an improved annular seal for embodiments of the resin-based sealant compositions.

Generally, the CKD may be included in the resin-based sealant compositions in an amount in a range of from about 1% to about 60% by volume of the resin-based sealant composition. In particular embodiments, the CKD may be included in the resin-based sealant compositions in an amount in a range of from about 20% to about 40% by volume of the resin-based sealant composition. In specific embodiments, the CKD may be present in an amount ranging between any of and/or including any of about of about 1%, about 10%, about 20%, about 30%, about 40%, about 50%, or about 60% by volume of the resin-based sealant composition. One of ordinary skill in the art, with the benefit of this disclosure, will recognize the appropriate amount of CKD to include for a chosen application.

While the preceding description describes CKD, the present invention is broad enough to encompass the use of other partially calcined kiln feeds. For example, embodiments of the resin-based sealant compositions may comprise lime kiln dust, which is a material that is generated during the manufacture of lime. The term “lime kiln dust” typically refers to a partially calcined kiln feed which can be removed from the gas stream and collected, for example, in a dust collector during the manufacture of lime. The chemical analysis of lime kiln dust from various lime manufactures varies depending on a number of factors, including the particular limestone or dolomitic limestone feed, the type of kiln, the mode of operation of the kiln, the efficiencies of the lime production operation, and the associated dust collection systems. Lime kiln dust generally may comprise varying amounts of free lime and free magnesium, lime stone, and/or dolomitic limestone and a variety of oxides, such as SiO₂, Al₂O₃, Fe₂O₃, CaO, MgO, SO₃, Na₂O, and K₂O, and other components, such as chlorides.

In some embodiments, the resin-based sealant compositions may further comprise a weighting material. As used herein, the term “weighting material” refers to any particulate matter added to the resin-based sealant composition to increase or lower density. Examples of weighting materials for lowering density include, but are not limited to hollow microspheres. Examples of suitable hollow microspheres include, but are not limited to, hollow mineral glass spheres, such as “SPHERELITE™” available from Halliburton Energy Services of Duncan, Okla.; silica and alumina cenospheres, such as “CENOLITE®” available from Microspheres S.A. of South Africa; hollow glass microspheres, such as “SCOTCHLITE™” available from the 3M Company of St. Paul, Minn.; ceramic microspheres, such as “Z-LIGHT SPHERES™” available from the 3M Company of St. Paul, Minn.; polymeric microspheres, such as “EXPANCEL®” available from Akzo Nobel of The Netherlands; and plastic microspheres, such as “LUBRA-BEADS®” available from Halliburton Energy Services, Inc. of Duncan, Okla. Examples of suitable weighting materials for increasing density include, but are not limited to, silica, ilmenite, hematite, barite, Portland cement, manganese tetraoxide, and combinations thereof. Specific examples of weighting materials for increasing density include, but are not limited to, MICROSAND™, a crystalline silica weighting material, and a hematite weighting material, both available from Halliburton Energy Services, Inc. of Duncan, Okla.

The mean particulate sizes of the weighting material may generally range from about 2 nanometers to about 3000 microns in diameter; however, in certain circumstances, other mean particulate sizes may be desired and will be entirely suitable for practice of the present invention. It should be understood that the term “particulate,” as used in this disclosure, includes all known shapes of materials, including substantially spherical materials, fibrous materials, polygonal materials (such as cubic materials), and mixtures thereof. In particular embodiments, the particulate size of the weighting material may be selected to impart a desired viscosity to the resin-based sealant composition. Moreover, in particular embodiments, weighting materials having different particulate sizes may be mixed to achieve a desired viscosity of the resin-based sealant composition.

Generally, the weighting material may be included in the resin-based sealant composition in an amount in a range of from about 1% to about 60% by volume of the resin-based sealant composition. In particular embodiments, the weighting material may be included in the resin-based sealant composition in an amount in a range of from about 20% to about 40% by volume of the resin-based sealant composition.

In some embodiments, the resin-based sealant compositions may further comprise swellable particles. As used herein, the term “swellable particle” refers to any particle that swells upon contact with oil, gas, a combination of oil and gas, and/or an aqueous fluid (e.g, water). Swellable particles suitable for use in embodiments of the present invention may generally swell by up to about 50% of their original size at the surface. Under downhole conditions, the amount of swelling may vary depending on the conditions presented. For example, in some embodiments, the amount of swelling may be at least 10% under downhole conditions. In particular embodiments, the amount of swelling may be up to about 50% under downhole conditions. However, as those of ordinary skill in the art, with the benefit of this disclosure, will appreciate, the actual amount of swelling when the swellable particles are included in a resin-based sealant composition may depend on the concentration of the swellable particles included in the composition, among other factors. In accordance with particular embodiments of the present invention, the swellable particles may be included in the resin-based sealant composition, for example, to counteract the formation of cracks in a resultant well-bore seat and/or micro-annulus between the well bore plug and the pipe string or the formation. In general, the swellable particles are capable of swelling when contacted by one or more of the previously mentioned fluids to inhibit fluid flow through the crack and/or micro-annulus. Accordingly, the swellable particles may prevent and/or reduce the loss of zonal isolation in spite of the formation of cracks and/or micro-annulus, potentially resulting in an improved annular seal for the resin-based sealant compositions.

Some specific examples of suitable swellable elastomers include, but are not limited to, natural rubber, acrylate butadiene rubber, polyacrylate rubber, isoprene rubber, choloroprene rubber, butyl rubber (IIR), brominated butyl rubber (BIIR), chlorinated butyl rubber (CIIR), chlorinated polyethylene (CM/CPE), neoprene rubber (CR), styrene butadiene copolymer rubber (SBR), sulphonated polyethylene (CSM), ethylene acrylate rubber (EAM/AEM), epichlorohydrin ethylene oxide copolymer (CO, ECO), ethylene-propylene rubber (EPM and EDPM), ethylene-propylene-diene terpolymer rubber (EPT), ethylene vinyl acetate copolymer, fluorosilicone rubbers (FVMQ), silicone rubbers (VMQ), poly 2,2,1-bicyclo heptene (polynorborneane), and alkylstyrene. One example of a suitable swellable elastomer comprises a block copolymer of as styrene butadiene rubber. Examples of suitable elastomers that swell when contacted by oil include, but are not limited to, nitrite rubber (NBR), hydrogenated nitrite rubber (HNBR, HNS), fluoro rubbers (FKM), perfluoro rubbers (FFKM), tetrafluorethylenelpropylene (TFE/P), isobutylene maleic anhydride. Other swellable elastomers that behave in as similar fashion with respect to oil or aqueous fluids also may be suitable for use in particular embodiments of the present invention. Furthermore, combinations of suitable swellable elastomers may also be used in particular embodiments of the present invention.

Some specific examples of suitable water-swellable polymers, include, but are not limited, to starch-polyacrylate acid graft copolymer and salts thereof, polyethylene oxide polymer, carboxymethyl cellulose type polymers, polyacrylamide, poly(acrylic acid) and salts thereof, poly(acrylic acid-co-acrylamide) and salts thereof, graft-poly(ethylene oxide) of poly(acrylic acid) and salts thereof, poly(2-hydroxyethyl methacrylate), poly(2-hydroxypropyl methacrylate), and combinations thereof. Other water-swellable polymers that behave in a similar fashion with respect to aqueous fluids also may be suitable for use in particular embodiments of the present invention. In certain embodiments, the water-swellable polymers may be crosslinked and/or ligitly crosslinked. Those of ordinaly skill in the art, with the benefit of this disclosure, will be able to select an appropriate swellable elastomer and/or water-swellable polymer for use in particular embodiments of the resin-based sealant compositions of the present invention based on a variety of factors, including the particular application in which the composition will be used and the desired swelling characteristics.

Generally, the swellable particles may be included in the resin-based sealant compositions in an amount sufficient to provide the desired mechanical properties. In some embodiments, the swellable particles may be present in the resin-based sealant compositions in an amount up to about 25% by weight of the hardenable resin. In some embodiments, the swellable particles may be present in the resin-based sealant compositions in a range of about 5% to about 25% by weight of the hardenable resin. In some embodiments, the swellable particles may be present in the resin-based sealant compositions in a range of about 15% to about 20% by weight of the hardenable resin.

In addition, the swellable particles that may be utilized may have a wide variety of shapes and sizes of individual particles suitable for use in accordance with embodiments of the present invention. By way of example, the swellable particles may have a well-defined physical shape as well as an irregular geometry, including the physical shape of platelets, shavings, fibers, flakes, ribbons, rods, strips, spheroids, beads, pellets, tablets, or any other physical shape. In some embodiments, the swellable particles may have a mean particle size in the range of about 5 microns to about 1,500 microns, in some embodiments, the swellable particles may have a mean particle size in the range of about 20 microns to about 500 microns. However, particle sizes outside these defined ranges also may be suitable for particular applications.

In some embodiments of the present invention, additional solid materials may also be included in the resin-based sealant composition to enhance the strength, hardness, and/or toughness of the resulting well-bore seal. These solid materials may include both natural and man-made materials, and may have any shape, including, but not limited to, beaded, cubic, bar-shaped, cylindrical, or mixtures thereof, and may be in any form including, but not limited to flake or fiber form. Suitable materials may include, but are not limited to, cellulose fibers, carbon fibers, glass fibers, mineral fibers, plastic fibers (e.g., polypropylene and polyacrylic nitrite fibers), metallic fibers, metal shavings, Kevlar fibers, basalt fibers, wollastonite, micas (e.g., phlogopites and muscovites), and mixtures thereof. In some embodiments, nanoparticies and/or nanofibers may also be included in the resin-based sealant composition, wherein the nanopartieles and/or nanofibers have at least one dimension less than 1 micron and, alternatively, less than about 100 nanometers.

Carbon fibers suitable for use in particular embodiments of the present invention include high tensile modulus carbon fibers which have a high tensile strength. In some embodiments, the tensile modulus of the carbon fibers may exceed 180 GPa, and the tensile strength of the carbon fibers may exceed 3000 MPa. Generally, the fibers may have a mean length of about 1 mm or less. In some embodiments, the mean length of the carbon fibers is from about 50 to about 500 microns. In particular embodiment, the carbon fibers have a mean length in the range of from about 100 to about 200 microns. In particular embodiments, the carbon fibers may be milled carbon fibers. Suitable, commercially available carbon fibers include, but are not limited to, “AGM-94” and “AGM-99” carbon fibers both available from Asbury Graphite Mills, Inc., of Asbury, N.J.

Metallic fibers suitable for use in particular embodiments of the present invention may include non-amorphous (i.e., crystalline) metallic fibers. In particular embodiments, the non-amorphous metallic fibers may be obtained by cold drawing steel, wires (i.e., steel wool). Suitable metallic fibers include, but are not limited to, steel fibers. Generally, the length and diameter of the metallic fibers may be adjusted such that the fibers are flexible and easily dispersible in the resin-based sealant composition, and the resin-based sealant composition is easily pumpable.

These additional solid materials may be present in the resin-based sealant composition of the present invention individually or in combination. Additionally, the solid materials of the present invention may be present in the resin-based sealant composition in a variety of lengths andlor aspect ratios. A person having ordinary skill in the art, with the benefit of this disclosure, will recognize the mixtures of type, length, and/or aspect ratio to use to achieve the desired properties of a resin-based sealant composition for a particular application.

In particular embodiments of the present invention, the liquid hardenable resin component, optional liquid hardening agent component, and CKD, as well as any of the additional optional additives (e.g., weighting material, swellable particles, additional solid materials) may be either batch-mixed or mixed on-the-fly. As used herein, the term “on-the-fly” is used herein to mean that a flowing stream is continuously introduced into another flowing stream so that the streams are combined and mixed while continuing to flow as a single stream as part of the on-going treatment. Such mixing may also be described as “real-time” mixing. On-the-fly mixing, as opposed to batch or partial hatch mixing, may reduce waste and simplify subterranean treatments. This is due, in part, to the fact that, in particular embodiments, if the components are mixed and then circumstances dictate that the subterranean treatment be stopped or postponed, the mixed components may become unusable. By having the ability to rapidly shut down the mixing of streams on-the-fly in such embodiments, unnecessary waste may be avoided, resulting in, inter alia, increased efficiency and cost savings. However, other embodiments of the present invention may allow thr batch mixing of the resin-based sealant composition. In these embodiments, the resin-based sealant composition may be sufficiently stable to allow the composition to be prepared in advance of its introduction into the well bore without the composition becoming unusable if not promptly introduced into the well bore.

Generally, embodiments of the resin-based sealant compositions of the present invention may be used for any of a variety different purposes in which the resin-based sealant composition may be prepared and allowed to harden. In some embodiments, the resin-based sealant composition may be introduced into a subterranean formation and allowed to harden. As used herein, introducing the resin-based sealant composition into a subterranean formation includes introduction into any portion of the subterranean formation, including, without Limitation, into a well bore drilled into the subtemmean formation, into a near well bore region surrounding the well bore, or into both. The resin-based sealant composition may be allowed to harden in the subterranean formation for a number of purposes including, without limitation: to isolate the subterranean fbrmation from a portion of the well bore; to support a conduit in the well bore; to plug a void in the conduit; plug a void in as cement sheath disposed in an annulus of the well bore; to plug a perforation; to plug void (e.g., micro-annulus) between the cement sheath and the conduit; to prevent the loss of aqueous or nonaqueous drilling fluids into loss circulation zones such as a void, vugular zone, or fracture; to plug a well for abandonment purposes; to form a temporary plug to divert treatment fluids; as a chemical packer to be used as a fluid in front of cement slurry in cementing operations; or to seal an annulus between the well bore and an expandable pipe or pipe string. For instance, the resin-based sealant composition may withstand substantial amounts of pressure, e.g., the hydrostatic pressure of a drilling fluid or cement slurry, without being dislodged or extruded. The resin-based sealant composition may set into a flexible, resilient and tough material, which may prevent further fluid losses when circulation is resumed. The resin-based sealant composition may also form a non-flowing, intact mass inside the loss-circulation zone. This mass plugs the zone and inhibits loss of subsequently pumped drilling fluid, which allows for further drilling.

In primary-cementing embodiments, for example, embodiments of the resin-based sealant composition may be introduced into a well-bore annulus such as a space between a wall of a well bore and a conduit (e.g., pipe strings, liners) located in the well bore or between the conduit and a larger conduit in the well bore. The resin-based sealant composition may be allowed to harden to form an annular sheath of the hardened composition in the well-bore annulus. Among other things, the hardened composition formed by the resin-based sealant composition may form a barrier, preventing the migration of fluids in the well bore. The hardened composition also may, for example, support the conduit in the well bore and/or form a bond between the well-bore wall and the conduit.

In some embodiments, the conduit may also be cemented into a well-bore annulus by utilizing what is known as a reverse-cementing method. The reverse-cementing method comprises displacing the resin-based sealant composition into the annulus between the conduit and the annulus between an existing string, or an open hole section of the wellbore. As the resin-based sealant composition is pumped down the annular space, drilling fluids ahead of the resin-based sealant composition are displaced around the lower ends of the conduit and up the inner diameter of the conduit and out at the surface. The fluids ahead of the resin-based sealant composition may also be displaced upwardly through a work string that has been run into the inner diameter of the conduit and sealed of at its lower end. Because the work string has a smaller inner diameter, fluid velocities in the work string will be higher and will more efficiently transfer the cuttings washed out of the annulus during placement of the resin-based sealant composition. In an embodiment, a small amount of resin-based sealant composition will be pumped into the conduit and the work string. As soon as a desired amount of resin-based sealant composition has been pumped into the annulus, the work string may be pulled out of its seal receptacle and excess resin-based sealant composition that has entered the work string can be reverse-circulated out the lower end of the work string to the surface.

In remedial-cementing embodiments, a resin-based sealant composition may be used, for example, in squeeze-cementing operations or in the placement of cement plugs. By way of example, the resin-based sealant composition may be placed in a well bore to plug voids, such as holes or cracks in the pipe strings; holes, cracks, spaces, or channels in the sheath; and very small spaces (commonly referred to as “micro-annuli”) between the sheath and the exterior surface of the pipe or well-bore wall.

It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range filling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower Or upper limit combined with any other point or individual value or any other lower or upper limit, to recite a range not explicitly recited.

Therefore, the present invention is well adapted to attain the ends and advantages mentioned as well as those that are inherent therein. The particular embodiments disclosed above are illustrative only as the present invention may be modified and practiced in different but equivalent, manners apparent to those skilled in the art having the benefit of the teachings herein. Although individual embodiments are discussed, the invention covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present invention. If there is any conflict in the usages of a word or term in this specification and one or more patent(s) or other documents that may be incorporated herein by reference, the definitions that are consistent with this specification should be adopted.

What is claimed is:

1. A method comprising:
providing a resin-based sealant composition comprising a liquid hardenable resin component and kiln dust; and
allowing the resin-based sealant composition to harden.

2. The method of claim 1 wherein the liquid hardenable resin component comprises a hardenable resin selected from the group consisting of an epoxy-based resin, a novolak resin, a polyepoxide resin, a phenol-aldehyde resin, a urea-aldehyde resin, a urethane resins, a phenolic resin, a furan resin, a furan/furfuryl alcohol resin, as phenolic/latex resin, a phenol formaldehyde resin, a bisphenol A diglycidyl ether resin, a butoxymethyl butyl glycidyl ether resin, a bisphenol A-epichlorohydrin resin, a bisphenol F resin, a glycidyl ether resin, a polyester resin and hybrids and copolymers thereof, a polyurethane resin and hybrids and copolymers thereof, an acrylate resins and any combination thereof.

3. The method of claim 1 wherein the resin-based sealant composition further comprises a liquid hardenable resin component, the liquid hardenable resin component comprising a hardening agent selected from the group consisting of an aliphatic amine, an aliphatic tertiary amine, an aromatic amine, a cycloaliphatic amine, a heterocyclic amine, an amido amine, a polyamide, a polyethyl amine, a polyether amine, a polyoxyalkylene amine, a carboxylic anhydride, a triethylenetetraamine, an ethylene diamine, a N-cocoalkyltrimethylene, an isophorone diamine, a N-aminophenyl piperazine, imidazoline, a 1,2-diaminocyclohexane, a polyetheramine, a diethyltoluenediamine, a 4,4′-diaminodiphenyl methane, a methyltetrahydrophthalic anhydride, a hexahydrophthalic anhydride, a maleic anhydride, polyazelaic polyanhydride, phthalic anhydride, and any combination thereof.

4. The method of claim 1 wherein the kiln dust comprises cement kiln dust.

5. The method of claim 1 wherein the kiln dust comprises lime kiln dust.

6. The method of claim 1 wherein the kiln dust is present in an amount in a range of from about 1% to about 60% by volume of the resin-based sealant composition.

7. The method of claim 1 wherein the kiln dust comprises cement kiln dust and is present in an amount in a range of from about 20% to about 40% by volume of the resin-based sealant composition, wherein the liquid hardenable resin composition is present in an amount in a range of from about 50% to about 75% by volume of the resin-based sealant composition and further comprises a solvent, and wherein the resin-based sealant composition further comprises a liquid hardenable resin component in an amount in a range of from about 5% to about 25% by volume of the resin-based sealant composition.

8. The method of claim 1 wherein the resin-based sealant composition further comprises a weighting material selected from the group consisting of hollow microspheres, silica, ilmenite, hematite, barite, Portland cement, manganese tetraoxide, and any combination thereof.

9. The method of claim 1 wherein the resin-based sealant composition further comprises a swellable particle.

10. The method of claim 1 wherein the resin-based sealant composition further comprises a component selected from the group consisting of cellulose fibers, carbon fibers, glass fibers, mineral fibers, plastic fibers, polypropylene fibers, polyacrylic nitrile fibers, metallic fibers, metal shavings, Kevlar fibers, basalt fibers, wollastonite, micas, phlogopites, muscovites, nanoparticles, nanofibers, and any combination thereof.

11. A method of forming a seal in a subterranean formation comprising:
introducing a resin-based sealant composition into a subterranean formation, wherein the resin-based sealant composition comprises a liquid hardenable resin component and cement kiln dust; and
allowing the resin-based sealant composition to harden in the subterranean formation.

12. The method of claim 11 wherein the liquid hardenable resin component comprises a hardenable resin selected from the group consisting of an epoxy-based resin, a novolak resin, a polyepoxide resin, a phenol-aldehyde resin, a urea-aldehyde resin, a urethane resins, a phenolic resin, a furan resin, a furan/furfuryl alcohol resin, a phenolic/latex resin, a phenol formaldehyde resin, a bisphenol A diglycidyl ether resin, a butoxymethyl butyl glycidyl ether resin, a bisphenol A-epichlorohydrin resin, a bisphenol F resin, a glycidyl ether resin, a polyester resin and hybrids and copolymers thereof, a polyurethane resin and hybrids and copolymers thereof, an acrylate resins, and any combination thereof.

13. The method of claim 11 wherein the resin-based sealant composition further comprises a liquid hardenable resin component, the liquid hardenable re sin component comprising a hardening agent selected from the group consisting of an aliphatic amine, an aliphatic tertiary amine, an aromatic amine, a cycloaliphatic amine, a heterocyclic amine, an amido amine, a polyamide, a polyethyl amine, as polyether amine, a polyoxyalkylene amine, as carboxylic anhydride, a triethylenetetraamine, an ethylene diamine, a N-cocoalkyltrimethylene, an isophorone diamine, a N-aminophenyl piperazine, imidazoline, a 1,2-diaminocyclohexane, a polyetheramine, a diethytoluenediamine, a 4,4′-diaminodiphenyl methane, a methyltetrahydrophthalic anhydride, a hexahydrophthalic anhydride, as maleic anhydride, a polyazelaic polyanhydride, a phthalic anhydride, and any combination thereof.

14. The method of claim 11 wherein the kiln dust comprises cement kiln dust.

15. The method of claim 11 wherein the kiln dust comprises lime kiln dust.

16. The method of claim 11 wherein the kiln dust is present in an amount in a range of from about 1% to about 60% by volume of the resin-based sealant composition.

17. The method of claim 11 wherein the kiln dust comprises cement kiln dust and is present in an amount in a range of from about 20% to about 40% by volume of the resin-based sealant composition, wherein the liquid hardenable resin composition is present in an amount in a range of from about 50% to about 75% by volume of the resin-based sealant composition and further comprises a solvent, and wherein the resin-based sealant composition further comprises a liquid hardenable resin component in an amount in a ramie of from about 5% to about 25% by volume of the resin-based sealant composition.

18. The method of claim 11 wherein the resin-based sealant composition is non-aqueous such that the kiln dust does not hydrate during the step of allowing the resin-based sealant composition to harden.

19. The method of claim 11 wherein the resin-based sealant composition further comprises a weighting material selected from the group consisting of hollow microspheres, ilmenite, hematite, barite, Portland cement, manganese tetraoxide, and any combination thereof.

20. The method of claim 11 wherein the resin-based sealant composition further comprises a swellable particle.

21. The method of claim 11 wherein the resin-based sealant composition further comprises as component selected from the group consisting of cellulose fibers, carbon fibers, glass fibers, mineral fibers, plastic fibers, polypropylene fibers, polyacrylic nitrile fibers, metallic fibers, metal shavings, Kevlar fibers, basalt fibers, wollastonite, micas, phlogopites, muscovites, nanoparticles, nanofibers, and any combination thereof.

22. The method of claim 11, further comprising allowing the kiln dust to hydrate when contacted by one or more aqueous fluids after the step of allowing the resin-based sealant composition to harden.

23. The method of claim 11, wherein the resin-based sealant composition is used in a primary-cementing method.

24. The method of claim 11, wherein the resin-based sealant composition is used in a remedial-cementing method.

25. The method of claim 11, wherein the resin-based sealant composition is used in a reverse-cementing method.

26. The method of claim 11, wherein the resin-based sealant composition is allowed to harden and form a resin sheath in a well-bore annulus between a conduit in the subterranean formation and a well-bore wall or between the conduit and a larger conduit in the subterranean formation.

27. The method of claim 11, wherein the resin-based sealant composition is allowed to harden to seal a void in a sheath located in a well-bore annulus or conduit in the subterranean formation, to seal a void in the subterranean formation, to seal a space between an interior surface of the sheath and the conduit, and/or to seal a space between an exterior surface of the sheath and the subterranean formation or a larger conduit in the subterranean formation.

28. A resin-based sealant composition comprising:
a liquid hardenable resin component; and
cement kiln dust.
